(19) United States
(12) Patent Application Publication
(10) Pub. No.: US 2026/0289479 A1
(43) Pub. Date: Sep. 24, 2026

(54) SYSTEM AND METHOD FOR REDUCING COGNITIVE LOAD IN MAPPING PHYSICAL ITEMS TO PHYSICAL STORAGE LOCATIONS

(71) Applicant: House Ruybe LLC, Merced, CA (US)

(72) Inventor: Robert Michael Simental Ruybe, Merced, CA (US)

(21) Appl. No.: 19/564,999

(22) Filed: Mar. 12, 2026

Related U.S. Application Data
(60) Provisional application No. 63/776,057, filed on Mar. 22, 2025.

(51) Int. Cl. G06Q 10/083

(52) U.S. Cl. CPC G06Q 10/083

(57) ABSTRACT

Embodiments herein provide a system and method for reducing cognitive load associated with mapping one or more physical items to one or more physical storage locations for placement of the one or more physical items in a structured storage environment. The system determines at least one target physical storage location from the one or more physical storage locations for the physical item by querying the digital mapping database and activates at least one visual indicator positioned adjacent to at least one target physical storage location for placement of the physical item by an operator, thereby reducing the cognitive load while maintaining operator control over physical item placement. The system is configured to modify at least one visual characteristic of the at least one activated visual indicator based on the conditional attributes. The system is adaptable for use across multiple application environments, such as postal, healthcare, warehouse, and manufacturing units.

### BACKGROUND

### Technical Field

Embodiments herein generally relate to physical item sorting, more particularly, to a system and method for reducing cognitive load associated with mapping physical items to physical storage locations for placement of the physical items in a structured storage environment, while maintaining operator control over physical item handling and placement.

### Description of the Related Art

Numerous industries require workers to sort and place physical items into structured storage environments based on item characteristics, destination information, or task requirements. Such environments include postal operations, healthcare facilities, warehouses, distribution centers, and manufacturing assembly systems. In these settings, items often arrive in an unsorted or partially organized state, and operators are responsible for manually identifying, classifying, and placing the items into designated locations.

In postal operations, manual casing refers to the process of sorting incoming mail into delivery sequence order for a carrier route. Mail typically arrives unsorted, and carriers organize it into casing stations customized with delivery addresses. This process commonly requires several hours per day and becomes significantly slower when carriers are unfamiliar with routes, thereby reducing operational efficiency and limiting available time for delivery activities.

Similar challenges arise in healthcare environments, where personnel distribute medications or medical items to patient-specific storage locations such as carts or cabinets. Manual verification and placement processes may be time-consuming and prone to error, particularly during periods of high workload, shift transitions, or when personnel are unfamiliar with specific procedures. Placement errors in such environments may create safety risks and operational liabilities.

In warehouse and order-fulfillment operations, workers pick items from inventory and place them into designated bins or containers for shipment. Manual picking processes may result in misplacement, incorrect orders, or delays, which can lead to increased operational costs and reduced customer satisfaction. Likewise, in manufacturing environments, workers assemble kits of components required for downstream assembly operations, and selection or placement errors may cause production delays, rework, or quality defects.

Across these domains, manual item sorting and placement tasks commonly involve high cognitive load, requiring operators to memorize or reference mappings between items and locations. Performance may vary significantly depending on operator experience, and error rates may increase under time pressure. Training new personnel to achieve proficiency may require substantial time and resources, and communicating special handling instructions or alerts during placement operations may be difficult.

Existing automated sorting systems have been developed for certain high-volume applications. Such systems may include conveyors, feeders, readers, transport paths, sorting bins, push-out mechanisms, elevators, bundling devices, robotic placement units, or combinations thereof. Although capable of processing large volumes of standardized items, these systems typically require substantial capital investment, facility infrastructure, and ongoing maintenance, and may be limited in their ability to handle irregularly shaped items, fragile objects, or items requiring special handling. Furthermore, such systems may lack flexibility for rapidly changing workflows or moderate-volume environments.

Certain assisted manual sorting systems combine human operation with automated guidance tools, including wearable input devices or indicator-based guidance systems. While such systems may improve efficiency in some contexts, they often require operator training, introduce additional equipment costs, and may create ergonomic concerns during prolonged use. Additionally, many such systems rely on centralized architectures that require continuous connectivity and provide limited adaptability to changing task conditions

Other guided placement systems, such as indicator-based picking systems used in warehouses or manufacturing environments, typically rely on simple visual indicators or numeric displays associated with storage locations. These systems often operate using single identification modalities, limited contextual guidance, and centralized task control. Consequently, they may provide restricted functionality, limited fault tolerance, and minimal integration across multiple data inputs or operational scenarios.

Accordingly, there exists a need for a system that provides spatially precise visual guidance for item placement while maintaining human control, supports multiple identification input modalities with unified processing, enables guidance based on item or conditional metadata, operates autonomously with local caching and fault tolerance, is deployable at moderate cost where full automation is impractical, reduces cognitive load and error rates across operators, and allows rapid reconfiguration for changing workflows or operational requirements.

### SUMMARY

According to a first aspect of the invention, a computer-implemented system for reducing cognitive load associated with mapping a plurality of physical items to a plurality of physical storage locations for placement of the plurality of physical items in a structured storage environment is provided. The system includes (i) the plurality of physical storage locations arranged in a predetermined spatial configuration within the structured storage environment, (ii) a plurality of visual indicators, where each visual indicator is positioned adjacent to at least one of the plurality of physical storage locations, (iii) an identification subsystem configured to receive an item identifier associated with each of the plurality of physical items via at least one input unit, and (iv) a processing unit operatively connected to the identification subsystem and to the plurality of visual indicators. The processing unit is configured to (i) receive the item identifier associated with a physical item from the identification subsystem, (ii) access a digital mapping database storing associations between a plurality of item identifiers and corresponding physical storage locations, (iii) determine, by querying the digital mapping database using at least one deterministic rule-based matching technique, at least one target physical storage location from the plurality of physical storage locations for the physical item, and (iv) activate at least one visual indicator positioned adjacent to the at least one target physical storage location by generating a control command corresponding to the at least one visual indicator, and activation of the at least one visual indicator identifies the at least one target physical storage location for placement of the physical item by an operator, thereby reducing the cognitive load while maintaining operator control over physical item placement.

In some embodiments, the system includes (i) a plurality of processing units, each associated with a respective structured storage environment, and (ii) a configuration management subsystem configured to distribute the digital mapping database to the plurality of processing units.

In some embodiments, the configuration management subsystem includes a central server configured to maintain master configuration data and synchronize the data to the plurality of processing units through a network communication, and each processing unit is configured to operate autonomously using locally stored configuration data when network connectivity is unavailable.

In some embodiments, the system includes (i) a fault management subsystem configured to detect failure of the at least one input unit or visual indicator, and to continue operation using at least one remaining functional input unit or visual indicator, and (ii) a session management subsystem configured to associate physical item placement operations with authenticated operators. The session management subsystem enforces session termination based on operator inactivity.

In some embodiments, the system normalizes the item identifier to a canonical representation by (i) converting the item identifier to a lowercase format, (ii) removing punctuation characters except required characters, (iii) standardizing whitespace within the item identifier, (iv) correcting predefined optical character recognition (OCR) errors, and (v) normalizing suffixes associated with the item identifier.

In some embodiments, the physical item includes a postal mail piece bearing delivery address information.

In some embodiments, the structured storage environment includes a mail casing station having shelves arranged according to delivery sequence.

In some embodiments, the item identifier includes delivery address text extracted through an optical character recognition.

In some embodiments, the physical item includes medication containers associated with individual patients.

In some embodiments, the item identifier includes at least one of patient identifiers, medication identifiers, or encoded prescription information.

In some embodiments, the physical item includes inventory items identified by stock-keeping units (SKUs).

In some embodiments, the structured storage environment includes bins arranged according to fulfillment or assembly workflows.

In some embodiments, authentication of the operator is performed via at least one of (i) numeric login code entry, (ii) machine-readable authentication token scanning, or (iii) manual operator selection. The numeric login code includes a site identifier, route identifier, and checksum component.

According to a second aspect of the invention, a computer-implemented system to resolve item identifier to at least one target storage location from a plurality of physical storage locations arranged in a predetermined spatial configuration within a structured storage environment is provided. The system includes an identification subsystem configured to receive the item identifier associated with each of the plurality of physical items via at least one input unit. The identification subsystem is configured to receive the item identifier through the at least one input unit including one or more of: (i) a numeric input through an alphanumeric input device, (ii) optical recognition through image capture and pattern recognition, (iii) machine-readable code scanning, or (iv) manual selection through user interface associated with the identification subsystem. The system includes a processing unit operatively connected to the identification subsystem. The processing unit is configured to resolve item identifier received from the at least one input device to the at least one target storage location using a common digital mapping.

In some embodiments, the optical recognition is performed using a graphics processing unit (GPU) that is configured to execute machine learning inference operations for the pattern recognition.

According to a third aspect of the invention, a computer-implemented system to modify at least one visual characteristic of at least one activated visual indicator is provided. The system includes (a) a processing unit operatively connected to a plurality of visual indicators, where each visual indicator is positioned adjacent to at least one of a plurality of physical storage locations. The processing unit is configured to (i) activate at least one visual indicator positioned adjacent to at least one physical storage location, and (ii) execute a metadata storage mechanism associating conditional attributes with at least one item identifier or at least one physical storage location, where an item identifier is associated with each of the plurality of physical items. The system includes visual indicator control subsystem configured to modify the at least one visual characteristic of the at least one activated visual indicator based on the conditional attributes. The conditional attributes comprise at least one of access restrictions, special handling requirements, hazard warnings, or time-sensitive conditions.

In some embodiments, the system includes a display unit configured to present conditional attribute details when the at least one visual characteristic of the at least one activated visual indicator is modified.

In some embodiments, the plurality of visual indicators includes individually addressable RGB light-emitting elements, and the at least one visual characteristic includes at least one of color, illumination pattern, or illumination duration.

In some embodiments, the conditional attributes include medication contraindications or allergy indicators.

According to a fourth aspect of the invention, a method for reducing cognitive load associated with mapping a plurality of physical items to a plurality of physical storage locations for placement of the plurality of physical items in a structured storage environment is provided. The method includes receiving an item identifier associated with a physical item from the identification subsystem that is operatively connected to a processing unit. The method includes accessing, by the processing unit, a digital mapping database storing associations between a plurality of item identifiers and corresponding physical storage locations. The method includes determining, by the processing unit, at least one target physical storage location from the plurality of physical storage locations for the physical item by querying the digital mapping database using at least one deterministic rule-based matching technique. The plurality of physical storage locations arranged in a predetermined spatial configuration within the structured storage environment. The method includes activating at least one visual indicator positioned adjacent to the at least one target physical storage location by generating a control command corresponding to the at least one visual indicator, and activation of the at least one visual indicator identifies the at least one target physical storage location for placement of the physical item by an operator, thereby reducing the cognitive load while maintaining operator control over physical item placement.

The system provides a multi-modal digital identification, dynamic identifier-to-location resolution, and spatially precise visual guidance within a distributed, fault-tolerant architecture. The system explicitly maintains human control over physical item placement, providing visual guidance while preserving operator control, thereby reducing placement errors arising from misread identifiers, forgotten mappings, time pressure, or operator unfamiliarity with environments. Thus, reducing liability, enables safety-critical applications (e.g., medication dispensing), and supports items requiring human assessment. The system accepts identification information from multiple modalities such as numeric input, optical recognition, machine-readable codes, manual selection and resolves all inputs using a unified digital mapping database, and thereby enabling operator choice of input method based on item characteristics, operator skill, or system performance, including fallback options when a primary modality is unavailable and extensibility for future input technologies.

The system provides a human-in-the-loop configuration rather than an automated sorting system. The system assists human operators by providing unambiguous spatial guidance but does not replace human decision-making or physical manipulation of items, thereby reducing cognitive load, eliminating memorization of identifier-to-location mappings, improving training speed, ensuring consistent performance across operators, and minimizing mental fatigue. The system modifies visual indicator characteristics such as color, pattern, duration based on conditional metadata associated with items or locations, enabling conveyance of safety alerts, special handling requirements, or time-sensitive conditions, and providing contextual operational information beyond binary indication systems.

The system employs distributed processing units with local configuration caching, enabling autonomous operation during network outages and degradation when components fail, while avoiding single points of failure and allowing scalable deployment through addition of processing units as operational demand increases. The system provides a platform architecture supporting multiple domains such as postal, healthcare, warehouse, manufacturing through common core technology with domain-specific configuration profiles, thereby enabling cross-domain operator training, shared software improvements across deployments, reduced development cost through platform reuse, and economies of scale in procurement and system maintenance.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a block diagram of a system for reducing cognitive load associated with mapping a one or more physical items to a one or more storage locations for placement of the one or more physical items in a structured storage environment according to some embodiments herein;

FIG. 2 illustrates an exploded view of a server of a processing unit of FIG. 1 according to some embodiments herein;

FIG. 3 illustrates an exploded view of a processing unit of FIG. 1 according to some embodiments herein;

FIG. 4A illustrates an exemplary view of a structured storage environment, which in one embodiment represented as a postal mail casing station, according to some embodiments herein;

FIG. 4B illustrates an exemplary view of a visual indicator connectivity, depicting multiple sets of LED strips connected to a processing unit according to some embodiments herein;

FIGS. 5A and 5B illustrate detailed view of a visual indicator, showing individual addressable elements and daisy-chain topology according to some embodiments herein;

FIG. 6A illustrates workflow for configuring conditional attributes or alerts in one or more processing units by a supervisor, including setting alerts for special handling requirements according to some embodiments herein;

FIG. 6B illustrates workflow for establishing network communication and defining alerts according to some embodiments herein;

FIG. 7 illustrates an exemplary implementation of a system deployed in a postal mail sorting environment;

FIG. 8 illustrates an exemplary view of a system implemented in a parcel locker configuration;

FIG. 9 is a flow diagram that illustrates a method for reducing cognitive load associated with mapping a plurality of physical items to a plurality of physical storage locations for placement of the plurality of physical items in a structured storage environment according to some embodiments herein; and

FIG. 10 is a schematic diagram of computer architecture in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

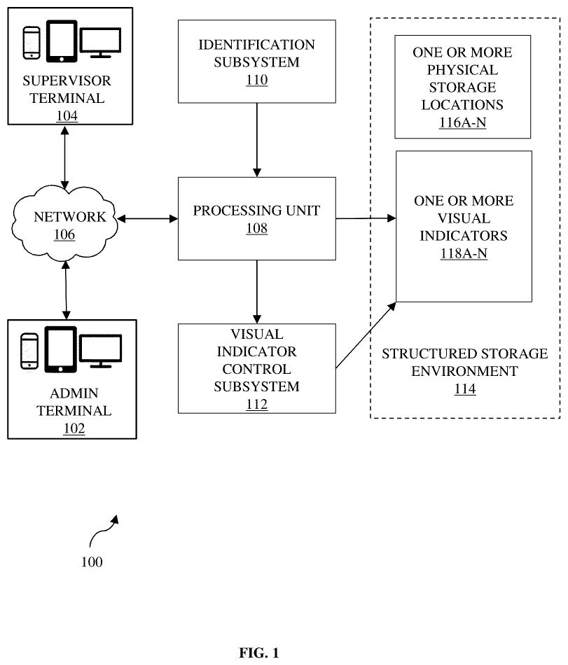

As mentioned, there remains a need for a system and method for reducing cognitive load associated with mapping a plurality of physical items to a plurality of physical storage locations for placement of the plurality of physical items in a structured storage environment. Referring now to the drawings, and more particularly, FIG. 1 through FIG. 10, where similar reference characters denote corresponding features consistently throughout the figures, preferred embodiments are shown.

FIG. 1 illustrates a block diagram of a system 100 for reducing cognitive load associated with mapping a one or more physical items to a one or more physical storage locations 116A-N for placement of the one or more physical items in a structured storage environment 114 according to some embodiments herein. The system 100 includes the one or more physical storage locations 116A-N, one or more visual indicators 118A-N, a processing unit 108, an identification subsystem 110, a visual indicator control subsystem 112, admin terminal 102, supervisor terminal 104 and a network 106. The one or more physical storage locations 116A-N are arranged in a predetermined spatial configuration within the structured storage environment 114. The one or more physical storage locations 116A-N may include shelves, bins, drawers, compartments, lockers, parcel lockers, or other containers capable of receiving items. The spatial configuration may be linear (e.g., shelves in delivery sequence), matrix-based (e.g., row/column grid), or hierarchical (e.g., cabinet/drawer/slot). In some embodiments, the structured storage environment 114 includes a casing station with multiple case slots, each having multiple shelves arranged in delivery sequence order.

The one or more visual indicators 118A-N are positioned adjacent at least one of the one or more physical storage locations 116A-N. The one or more visual indicators 118A-N provide spatial guidance by illuminating to indicate target placement locations. In an embodiment, the one or more visual indicators 118A-N include addressable red, green, blue light-emitting diode (RGB LED) strips (e.g., WS2812B or SK6812 chipsets) with 60 individual LEDs per meter. The LED strips are mounted along the front edge of each shelf, providing spatially precise indication of the target physical storage location. The individually addressable nature enables single-LED illumination (indicating a specific location) or multi-LED illumination (indicating a range or zone). In another embodiment, the one or more visual indicators employ organic light emitting diode (OLED) display elements, E-ink indicators, projection-based guidance (projected highlights, mechanical indicators (motorized pointers) and audio guidance combined with visual indication.

The one or more physical items may include postal pieces bearing delivery address information, medication containers associated with individual patients and inventory items identifies by stock-keeping units. The item identifier may include delivery address text extracted through an optical character recognition, and least one of patient identifiers, medication identifiers, or encoded prescription information.

The admin terminal 102 is used by an admin to disable or enable existing supervisor names, add processing unit 108A, and configure specific visual indicators characteristics as per the needs. The supervisor terminal 104 is used by a supervisor to access and manage each processing unit 108 for adding, updating and deleting conditional attributes or alerts. The supervisor also able to read data from the processing unit 108 for analysis and reporting. The supervisor using the software application is able to set or clear the conditional attributes at the processing units 108 for access restrictions, special handling requirements, hazard warnings, or time-sensitive conditions. The supervisor is allowed to manage Change of Address across processing unit 108. The supervisor and the admin are able to access and manage each processing unit 108 using a software application that is accessed using the supervisor terminal 104 and the admin terminal 102. The admin and the supervisor may successfully login on to the software application using user credentials. The software application may be a graphical user interface (GUI) based window application that helps in initial setup to configure the processing unit 108.

The Admin terminal 102 and the supervisor terminal 104 may be a handheld device, a mobile phone, a kindle, a Personal Digital Assistant (PDA), a tablet, a laptop, a desktop computer, a wearable device, an electronic notebook, a smartphone, a stationary device, a partially-stationary device or a non-traditional user device like IoT (Internet of Things) nodes. The admin terminal 102, supervisor terminal 104 and the processing unit 108 connected to each other through the network 106. In some embodiments, the network 106 is a wired network, a wireless network, or an Ethernet network. In some embodiments, the network 106 is a combination of a wired, wireless, and Ethernet network. In some embodiments, the network is Internet.

The processing unit 108 is configured through initial pairing that is done during commission of one or more processing units 108A-N. Each processing unit 108 has fixed internet protocol (IP) addresses and same need to be configured in the software application for communication between them. Each processing unit 108 has a unique device identity, a manufacturing serial number and the software application to recognize it and exchange data.

In an embodiment, the processing unit 108 includes an embedded graphics processing unit (GPU) accelerated platform (NVIDIA Jetson Orin Nano) with: (i) advanced reduced instruction set computer machine (ARM) central processing unit (CPU) cores for general processing, (ii) NVIDIA GPU with compute unified device architecture (CUDA) support for machine learning inference, (iii) sufficient random access memory (RAM) for in-memory database caching (8 GB+), (iv) network connectivity (Ethernet, WiFi), (v) universal serial bus (USB) interfaces for peripheral connections, (vi) general purpose input/output (GPIO) or serial interfaces for visual indicator control. The GPU acceleration enables real-time optical character recognition at suitable frame rates for operational deployment. In another embodiment, the processing unit employs (i) alternative GPU platforms (AMD, Intel, Apple Silicon), (ii) NPU (Neural Processing Unit) acceleration, (iii) TPU (Tensor Processing Unit) acceleration, (iv) CPU-only processing for lower-throughput applications, and (v) cloud-based processing with local caching.

The processing unit 108 is equipped with a small server that manages the operations and data processing. In some embodiments, a PostgreSQL database is integrated within the processing unit to handle data storage, synchronization and communication with the Admin terminal 104 or supervisor terminal 102 for centralized management. The server includes a memory that stores a database, a processor that executes a set of instructions. The database may store one or more sequences of instructions.

The authentication of the operator is performed via at least one of (i) numeric login code entry, (ii) machine-readable authentication token scanning, or (iii) manual operator selection. The numeric login code includes a site identifier, route identifier, and checksum component. The numeric codes enable personal identification number (PIN) pad authentication without requiring magnetic cards or biometric devices. The machine-readable authentication tokens include quick-response (QR) codes or barcodes encoding profile identifiers. The operators scan authentication tokens to load profiles and establish sessions. The manual operator selection includes administrative interface allows direct profile selection for testing or when authentication tokens are unavailable.

Upon authentication, the operator/automated feeder presents the physical item to an identification subsystem 110. The identification subsystem 110 is configured to receive the item identifier associated with a physical item through the at least one input unit including one or more of: (i) a numeric input through an alphanumeric input device, (ii) optical recognition through image capture and pattern recognition, (iii) machine-readable code scanning, or (iv) manual selection through user interface associated with the identification subsystem 110. The processing unit 108 is operatively connected to the identification subsystem 110 and to the plurality of visual indicators 118A-N. The optical recognition is performed using a graphics processing unit (GPU) that is configured to execute machine learning inference operations for the pattern recognition. The GPU enabled real-time optical character recognition (OCR) processing at suitable frame rates, machine learning model inference, concurrent processing of multiple services and future model upgrades without hardware changes.

The alphanumeric input device (i.e. physical keypad or software keyboard) enabling direct entry of item identifiers. In a postal embodiment, carriers (i.e. operators) enter street numbers directly (e.g., “742” for 742 Main Street). The system 100 resolves the numeric item identifier to matching addresses and activates corresponding visual indicators. The numeric input provides deterministic resolution with high accuracy for correctly entered identifiers and average input time may be 1-2 seconds per item.

The optical recognition through an image capture device (i.e. camera) coupled with pattern recognition processing (OCR engine). In the postal embodiment, a camera captures images of mail pieces bearing printed addresses. A GPU-accelerated OCR engine (EasyOCR or PaddleOCR running on PyTorch) extracts address text. The system 100 normalizes extracted text, resolves it to route addresses, and illuminates corresponding visual indicators. The optical recognition enables hands-free operation but requires well-formed text and good image quality and the processing time is suitable for real-time operation.

The machine-readable code scanning includes an optical scanner configured to decode machine-readable codes (barcodes, QR codes, DataMatrix codes). In the postal embodiment, QR codes encode profile identifiers for operator authentication. In a healthcare embodiment, patient wristband barcodes identify patient-specific medication bins. In a warehouse embodiment, SKU barcodes identify inventory items. The code scanning provides reliable identification for items bearing machine-readable codes.

The operator may also use a user interface enabling direct selection of physical items or locations from displayed lists or graphical representations. The manual selection provides a fallback when other modalities are unavailable or when operators need to override automated identification. Thus, the system 100 provides multiple distinct input modalities resolving to physical storage locations such as (i) operator choice based on item characteristics or operator skill, (ii) fallback options when primary modalities fail, (iii) performance optimization (fast modalities for routine items, slower modalities for difficult items), (iv) future extensibility where new modalities added without architectural changes.

Regardless of input modality, all item identifiers are resolved using a unified digital mapping database. The processing unit 108 does not employ separate lookup logic for each modality, rather, all modalities produce item identifiers that query the same mapping table. For example: keypad input “742”→normalize→query mapping [“742*”]→LEDs [15, 16, 17]; OCR extracts “742 MAIN ST”→normalize→query mapping [“742 MAIN ST”]→LEDs [15, 16, 17]; QR code decodes “Route_1111”→load profile→numeric input ready. The system 100 ensures consistency across modalities, and enables seamless operator switching between input methods.

The processing unit 108 normalizes the item identifier to a canonical representation by (i) converting the item identifier to a lowercase format, (ii) removing punctuation characters except required characters, (iii) standardizing whitespace within the item identifier, (iv) correcting predefined OCR errors, and (v) normalizing suffixes associated with the item identifier. The processing unit 108 is configured to access a digital mapping database storing associations between one or more item identifiers and corresponding one or more physical storage locations 116A-N.

The processing unit 108 is configured to determine at least one target physical storage location from the one or more physical storage locations 116A-N for the physical item by querying the digital mapping database using at least one deterministic rule-based matching technique. The digital mapping database associates item identifiers with target physical storage locations (represented by visual indicator addresses). The digital mapping database structure varies by application domain. For example, in postal mail embodiment: {“742 MAIN ST”: {“led”: 15, “metadata”: {...}}, “744 MAIN ST”: {“led”: 16, “metadata”: {...}}, “750 MAIN ST”: {“led”: 17, “metadata”: {...}}, ...}. For example, in healthcare embodiment: {“PATIENT_304B”: {“led”: 42, “metadata”: {“allergies”: [“penicillin”], ...}}, “PATIENT_305A”: {“led”: 43, “metadata”: {...}}, ...}. For example, in warehouse embodiment: {“SKU_12345”: {“led”: 88, “metadata”: {“zone”: “A”, ...}}, “SKU_12346”: {“led”: 89, “metadata”: {...}}, ...}.

The digital mapping database supports (i) one-to-one mappings (single identifier to single location), (ii) One-to-many mappings (single identifier to multiple physical storage locations for distributed items), (iii) prefix matching (partial identifiers match multiple entries, and (iv) fuzzy matching with weighted token similarity (OCR error correction). The digital mapping database storage is local to each processing unit 108 enabling autonomous operation with optional synchronization to central configuration servers enabling distributed management. The Processing unit 108 queries digital mapping with normalized item identifier. The at least one deterministic rule-based matching technique may be an exact matching technique where item identifier matches single database entry, a prefix matching technique where item identifier matches multiple entries, or a Fuzzy matching technique where OCR errors are corrected using weighted token similarity. The query returns one or more matches with visual indicator addresses (i.e. present adjacent to the target physical storage location) and metadata. If no matches found, operator is notified via display unit or audible alert through a buzzer.

The processing unit 108 is configured to activate at least one visual indicator positioned adjacent to the at least one target physical storage location by generating a control command corresponding to the at least one visual indicator. The processing unit 108 generates control commands to the visual indicator drivers, which activates the at least one visual indicator positioned adjacent to the at least one target physical storage location. The activation of the at least one visual indicator identifies the at least one target physical storage location for placement of the physical item by an operator, thereby reducing the cognitive load while maintaining operator control over physical item placement. The operator places the physical item at the visually indicated physical storage location (i.e. the target physical storage location), thereby reduces cognitive load that is the operator does not need to memorize item-to-location mappings, while preserving operator judgement in final placement decision.

The system 100 modifies at least one visual characteristic of at least one activated visual indicator by executing a metadata storage mechanism associating conditional attributes/metadata with at least one item identifier or at least one physical storage location using the processing unit 108. The visual indicator control subsystem 112 is configured to modify the at least one visual characteristic of the at least one activated visual indicator based on the conditional attributes. The conditional attributes are stored in association with item identifiers or one or more physical storage locations 116A-N within the digital mapping database.

In the postal mail embodiment, the conditional attributes may include hazard warnings (dangerous animal at address, unsafe access), hold mail requests (vacation hold, customer request), forwarding addresses (Change of Address on file), legal restrictions (court-ordered delivery suspension), vacancy indicators (unoccupied address), mailbox blockages (obstruction reported, deceased resident flags.

In the healthcare embodiment, the conditional attributes may include medication contraindications (drug allergies, drug-drug interactions, patient isolation precautions (contact isolation, airborne precautions, time-sensitive windows (administer within 30-minute window, nothing by mouth restriction (NPO status), high-alert medication flags (requires double-check, controlled substance tracking (Drug Enforcement Administration (DEA) schedule II-V)).

In the warehouse embodiment, the conditional attributes may include fragile item indicators (special handling required), temperature-controlled items (refrigeration required), hazardous materials (special packaging, documentation, high-value items (security protocols, expiration date tracking (FEFO—first expired, first out).

The visual indicator control subsystem 112 modifies at least one visual characteristic based on conditional attributes. The visual characteristic includes at least one of color, illumination pattern, or illumination duration. The processing unit 108 sends commands to the LED driver with LED address, color, pattern and duration to modify the visual characteristics. The modified characteristics include color modification that is RGB addressable indicators can display distinct colors such as white for standard operation (no special conditions, red for hazard warning or contraindication (do not proceed without verification), yellow for caution or hold condition (requires attention), blue for informational alert (forwarding address, location change), green for confirmation or priority indicator. The supervisor may configure the color mappings.

The modified visual characteristics include pattern modification that is temporal illumination patterns convey urgency or severity such as solid for standard indication, slow pulse for informational alert, fast pulse for warning condition and rapid flash for critical alert requiring immediate attention. The modified visual characteristics include duration modification that is illumination duration may be extended for the physical items requiring additional attention or verification steps. The modified characteristics include intensity modification that is brightness levels may be adjusted to draw attention or accommodate varying ambient light conditions. In an embodiment, color modification is primary. When an address with a hazard warning is matched, the corresponding LEDs illuminate in red rather than white.

The system 100 includes a display unit that is configured to present conditional attribute details when the at least one visual characteristic of the at least one activated visual indicator is modified. The display unit may be positioned at the operator's workstation, typically mounted above or beside the structured storage environment 114. In an embodiment, the display unit includes an LCD display (5-7 inches diagonal) that shows (i) current system state (idle/active/maintenance), (ii) active operator identification, (iii) current session profile name and type, (iv) most recently processed item identifier, (v) conditional alert details (when applicable), and (vi) real-time operational metrics (items processed, accuracy rate, average time). For example, the display content for standard operation display may be in the format of:
“ACTIVE—Route_1111 (station)
Operator: John Smith
Session: 00:14:32
Last: 742 MAIN ST
Count: 127|Success: 98%
Avg Time: 4.2s”
For example, the display content for conditional alert display in postal mail embodiment may be in the format of:
“ALERT: 742 MAIN ST Type: HOLD MAIL
Reason: Vacation hold
Until: 01/15/25
Contact: (555) 123-4567”

For example, the display content for conditional alert display in healthcare embodiment may be in the format of:
“DRUG ALLERGY ALERT Patient: Room 304-B
Medication: Penicillin s
Allergy: Beta-lactam
DO NOT ADMINISTER
Verify with physician”

The display unit enhances the effectiveness of visual indicator color coding by providing actionable detail. The operator seeing red LED illumination may reference the display for specific guidance. After placement of each physical item at a designated physical storage location indicated by the activated visual indicators, the processing unit 108 clears the visual indicator activation (i.e. LED illumination) to avoid ambiguity for subsequent operations, either automatically or in response to a manual clear command entered by the operator. The system 100 then resets operational parameters by clearing the current identifier, updating session metrics including processed item count and timing statistics, and refreshing the display unit with updated information, while remaining in an active session state ready to receive the next item identification. An activity timestamp corresponding to the most recent interaction is recorded for session monitoring, enabling a session management subsystem to enforce inactivity-based termination if no further activity is detected within a configurable timeout interval. A session may terminate upon explicit logout input, automatic timeout, or administrative shutdown. The processing unit 108 stops associated processes, clears loaded profiles, releases resources, and transitions the system 108 to an idle state prepared for subsequent authentication.

In some embodiments, the system includes one or more processing units 108A-N, each associated with a respective structured storage environment, which enables scalability (add processing units as needed), fault isolation (failure of one unit does not affect others), local autonomy (units operate independently), and centralized management (optional configuration server). The system further includes a configuration management subsystem that is configured to distribute the digital mapping database to the one or more processing units 108A-N. The configuration management subsystem includes a central server configured to maintain master configuration data and synchronize the data to the one or more processing units 108A-N through the network 106. The master configuration data may include profile definitions, operator authentication indices, site configurations settings and software update packages. The one or more processing units 108A-N synchronize configuration data from the central server via network 106. The synchronization may occur (i) on-demand (operator initiates sync), (ii) scheduled (periodic automatic sync), and (iii) event-driven (triggered by configuration updates). Each processing unit 108 is configured to operate autonomously using locally stored configuration data when network 106 connectivity is unavailable and so recognizes that network outages occur and the one or more processing units 108A-N must continue functioning.

The system 100 may also operate in various operational modes such as networked mode, standalone mode, and hybrid mode. In the networked mode, the processing unit 108 is connected to central server, real-time configuration sync available. In standalone mode, the processing unit 108 operates with local configuration cache, no network dependency. In hybrid mode, the processing unit 108 is connected to network but uses local cache for primary operations, syncing opportunistically. The local configuration storage employs persistent storage (solid-state drive (SSD), embedded multi-media card (eMMC)), profile caching (active profiles loaded to RAM), atomic file operations (ensuring data consistency), and version tracking (enabling conflict resolution).

The system 100 includes a fault management subsystem configured to detect failure of the at least one input unit or visual indicator, and to continue operation using at least one remaining functional input unit or visual indicator. The fault tolerance is implemented across multiple tiers such as process-level fault detection and recovery, system-level fault detection and recovery, hardware-level fault detection and recovery, and multi-modal graceful degradation.

The process-level fault detection and recovery includes health check endpoints polled periodically, heartbeat signals from worker processes to controller, automatic process restart upon crash detection, and retry limits prevent infinite restart loops. The system-level fault detection and recovery includes system watchdog integration for container-level monitoring, docker restart policies (unless-stopped) for automatic container recovery, and graceful shutdown sequences (configurable grace period). The hardware-level fault detection and recovery includes camera device reconnection upon USB disconnect/reconnect, visual indicator controller serial port recovery, and network interface monitoring and automatic reconnection.

The multi-modal graceful degradation includes detecting failure of at least one identification modality or visual indicator and to continue operation using at least one remaining functional modality. For example, in the event of a camera failure, the system 100 may (i) detect a camera disconnection or frame acquisition failure condition, (ii) determine that an optical character recognition (OCR) modality associated with the camera is unavailable, (iii) verify that alternative input modalities, including a numeric keypad and QR code scanning, remain operational, (iv) notify the operator of reduced capability, and (v) continue operation by accepting identification input via the available numeric or QR code modalities. In another example, in the event of a visual indicator control failure, the system 100 may (i) detect a loss of communication with a LED controller, such as an LED driver module, (ii) designate the visual guidance subsystem as unavailable, (iii) determine that an operator display interface remains functional and present target physical storage location information in textual or graphical form, and (iv) log diagnostic information while permitting the operator to place items based on the display guidance rather than LED guidance.

The system 100 includes a session management subsystem configured to associate physical item placement operations with authenticated operators. The session management subsystem enforces session termination based on operator inactivity. The session management subsystem provides (i) operator accountability (who performed which placements), (ii) profile context (which configuration is active), (iii) performance metrics (per-operator efficiency tracking), and (iv) security (unauthorized access prevention). In the common digital mapping, profiles define associations between the one or more physical storage locations 116A-N and one or more visual indicators 118A-N address mappings, associations between item identifier and one or more physical storage locations 116A-N, and associations between the conditional attributes and the item identifier or one or more visual indicators 118A-N. The profiles are stored as structured data files such as JSON, XML, or similar database format in a profile storage. Upon authentication, the processing unit 108 receives authentication credentials and queries login index that is mapping credentials to profile name. The processing unit 108 loads profile data from storage and validates profile structure. The processing unit 108 transmits the validated profile data to operator modules. The operator modules cache the profile data in memory for subsequent access. The system 100 may enforce reasonable limits on the number of active profiles or addresses per profile to manage memory and complexity.

In some embodiments, the system 100 operates using a multi-process software architecture including a controller process, an application programming interface (API) service, a supervisory process, and one or more worker processes including a keypad worker, a QR worker, and a numeric login worker. The controller process functions as a central orchestration engine configured to manage state transitions, coordinate worker processes, and enforce operational rules. The API service provides administrative and profile management functionality through network-accessible interfaces, while the vision service performs image acquisition and optical character recognition processing. The worker processes handle respective input processing and authentication tasks. The processes communicate through inter-process communication mechanisms including Unix domain sockets, shared memory, or message queues, where control commands are transmitted to the controller and configuration or state instructions are distributed to workers. The supervisory process monitors the processes and enforces automatic restart, start-up sequencing, graceful shutdown, and resource usage limits.

The system 100 operates according to a defined state machine including an idle state, an active state, and a maintenance state. The system 100 transitions from idle state to active state upon successful operator authentication, transition from active state to idle state occurs upon logout or inactivity timeout, transition from any state to maintenance occurs upon administrative command, and exit from maintenance returns the system 100 to idle. The processing unit 108 enforces transition rules, broadcasts state changes, manages worker lifecycle operations, and monitors process heartbeat signals. During operation, the system 100 executes a session lifecycle including authentication, profile loading, item identification processing, activity monitoring, and automatic termination after a configurable inactivity timeout. The timeout mechanism enhances security, resource efficiency, and operational reliability by unloading profiles and requiring reauthentication. In some embodiments, a grace interval is applied following activation to prevent premature timeout.

The system 100 may also be employed across multiple application domains, including postal mail handling, healthcare medication dispensing, pharmacy prescription fulfillment, warehouse order fulfillment, manufacturing parts kitting, evidence tracking and chain-of-custody management, and laboratory specimen routing. For example, in a healthcare medication dispensing implementation, the physical item may include medication containers such as unit-dose packages, syringes, or IV bags, and the item identifiers may include patient identifiers, medication National Drug Codes (NDC), prescription order numbers, or barcode-encoded labels. The structured storage environment 114 may include medication carts having patient-specific drawers, automated dispensing cabinet bins, or other compartmentalized storage units, while the input modalities may include patient wristband barcode scanning, medication barcode scanning, numeric entry, or manual entry.

In operation, the nurse acting as the operator scans a patient wristband corresponding to an item identifier (e.g., PATIENT_304B), upon which the system retrieves medication orders associated with the patient and determines one or more physical storage locations 116A-N of prescribed medications. The system 100 then activates one or more visual indicators 118A-N, such as LEDs, at bins containing the prescribed medications to guide retrieval. The nurse selects a first medication and scans the medication barcode, after which the system 100 verifies whether the scanned medication matches the prescription data. If a match is detected, the system 100 provides a confirmation indication, such as a green LED signal, allowing the nurse to retrieve the medication, whereas if a mismatch or contraindication is detected, the system 100 generates an alert indication, such as a red LED signal, and causes a display to present error details. The process is repeated for remaining prescribed medications until completion, after which the system 100 logs the administered medications for recordkeeping and verification purposes.

The system 100 may further evaluate contextual or patient-specific conditional attributes/metadata prior to activating indicators, including drug allergy information, drug interactions, NPO status, isolation precautions, high-alert medication flags, dosage timing constraints, or other clinical restrictions, and may modify indicator behavior or generate alerts when such conditions are present. Such implementation may advantageously reduce wrong-patient medication errors, decrease verification time during medication rounds, automate allergy and interaction checking at point of selection, and enable automatic updating of medication administration records.

In a warehouse order fulfillment implementation, the physical items such as consumer products or industrial parts, each item being associated with item identifiers including stock keeping units (SKUs), or product names, are stored within a structured storage environment 114 including warehouse shelving, bin walls, or pallet racks. The operator receives an order list and scans an order identifier, such as an order barcode, to initiate processing. In response, the system 100 determines one or more physical storage locations 116A-N corresponding to items included in the order and activates one or more visual indicators 118A-N at bin locations containing the required items. The operator then traverses the structured storage environment 114 and retrieves items from illuminated bins, scanning each item identifier after retrieval so that the system 100 verifies correspondence between the scanned item and order data. Upon confirmation of a correct pick, the system 100 deactivates the corresponding visual indicator and updates inventory records in real time. If an incorrect item is scanned or if conditional metadata associated with the item indicates special handling requirements, including fragile status, hazardous classification, temperature-controlled storage, or high-value designation, the system 100 generates an alert indication and provides guidance through a display unit or indicator output. The process continues until all items in the order are confirmed, after which the system 100 records completion of the fulfillment operation, thereby reducing picking errors, increasing picking speed, improving inventory accuracy, and enabling context-sensitive visual guidance compared to conventional systems.

In evidence tracking and chain-of-custody management implementation, physical items such as evidence bags or document folders, each item being associated with item identifiers including case numbers or evidence item numbers are stored within a structured storage environment 114 including evidence lockers or secure cabinets. When an officer needs to retrieve evidence for court presentation or laboratory analysis, the officer inputs or scans the relevant item identifiers, prompting the system 100 to determine the corresponding one or more physical storage locations 116A-N and activate one or more visual indicators 118A-N at the locker containing the requested item. Upon retrieval, the officer scans the item to log removal, and the system 100 automatically records chain-of-custody information including officer identity and timestamp. When the evidence is returned, the system 100 again activates the appropriate physical storage location, logs placement, and updates custody records. The conditional attributes such as biohazard warnings, refrigeration requirements, high-security dual-custody status, or court-date alerts may be presented through visual or display units to ensure compliance with handling protocols, thereby maintaining evidentiary integrity, enabling rapid retrieval, and supporting regulatory or legal compliance.

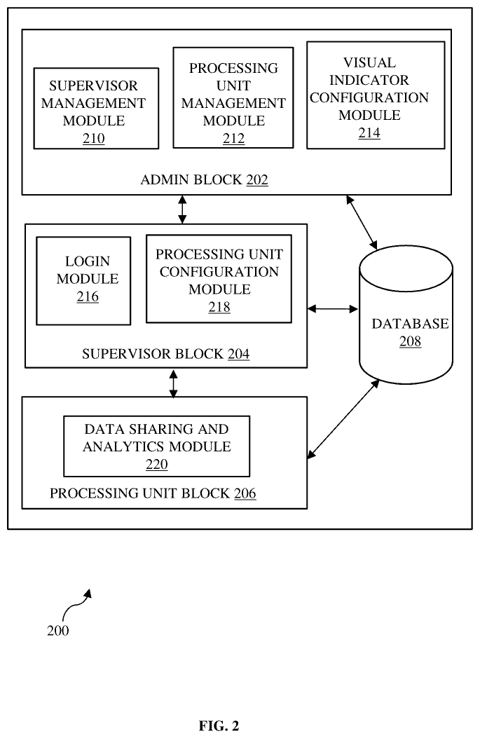

FIG. 2 illustrates an exploded view of a server 200 of a processing unit 108 of FIG. 1 according to some embodiments herein. The server 200 of the processing unit 108 allows structured access to different functional blocks including an Admin Block 202, a supervisor block 204, and a processing unit block 206, all interconnected through a database 208. The database 208 stores one or more sequences of instructions. The admin block 202 is accessed by the admin to access and manage the processing unit 108 and the supervisors. The admin block 202 includes a supervisor management module 210, a processing unit management module 212 and a visual indicator configuration module 214. The supervisor management module 210 allows the admin to add new supervisor credentials and delete existing supervisor credentials based as per needs. The processing unit management module 212 allows admin to add and delete the processing unit 108 as per needs. The visual indicator configuration module 214 allows admin to configure specific visual characteristics as per needs. The supervisor block 204 is accessed by the supervisor to manage the processing unit 108. The supervisor block 204 includes a login module 216 and a processing unit configuration module 218. The Login module 216 allows the supervisor to access software application through authentication using credentials provided by the Admin. The processing unit configuration module 218 allows the supervisor to access the processing unit 108 to add, update and delete the conditional attributes or alerts. The processing unit block 206 includes a data sharing and analytics module 220 that allows the supervisor to read the data from the processing unit 108 for analysis and reporting. The data sharing and analytics module 220 allows supervisor to pull the data from the processing unit 108 as per the need and store it locally for analysis, various reports can be prepared to help in decision making.

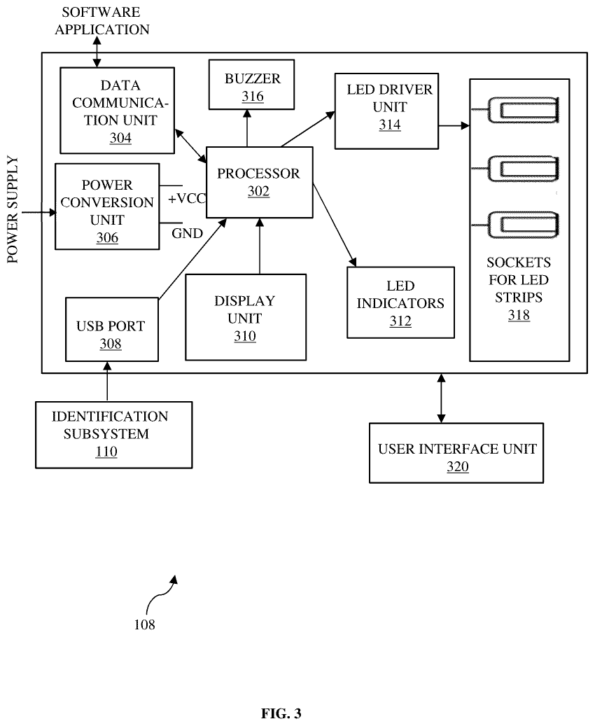

FIG. 3 illustrates an exploded view of a processing unit 108 of FIG. 1 according to some embodiments herein. The processing unit 108 includes a processor 302, a data communication unit 304, a power conversion unit 306, a Universal Serial Bus (USB) port 308, an identification subsystem 110, a display unit 310, LED indicators 312, a LED driver unit 314, a buzzer 316, sockets for LED strips 318 and a user interface unit 320. The processor 302 serves as the main control unit and enables the development of applications within the Operating System (OS) kernel. The identification subsystem 110 may be an image capturing unit. The processor 302 controls the identification subsystem 110 for image capture and performs image processing tasks including autofocus, image rotation, and alignment. The identification subsystem 110 transmits the item identifier to the processor 302 for further processing. In some embodiments, the identification subsystem 110 is a low-resolution camera and capturing an may take less than or equal to 200 milliseconds (ms). The processor 302 also controls the LEDs on the LED strips (i.e. visual indicator) and the buzzer 316. The processor 302 may be a Raspberry pi 4 model B with 8 GB Random Access Memory (RAM) to build python application on Linux OS. In some embodiments, the processor 302 is a multi-core ARM or x86 architecture processor, configured to execute instructions stored in a memory of the processing unit 108.

The data communication unit 304 facilitates data transmission between the software application and the processor 302, enabling bidirectional communication for processing and control. The data communication unit 304 utilizes the network for data transfer. The data communication unit 304 may include one or more network interfaces comprising Ethernet connectivity and optional wireless communication interfaces. The power conversion unit 306 converts the 110V mains input into the required operating voltage to power the processing unit 108. In some embodiments, the power conversion unit 306 may include a Switched-Mode Power Supply (SMPS) for efficient voltage regulation and stable power delivery. In some embodiments, a dedicated power supply is provided for the LED strips to prevent LED current draw from affecting stability of the processing unit 108. The USB port 308 facilitates communication between the identification subsystem 110 and the processor 302. The connection enables transfer of captured images from the identification subsystem 110 to the processor 302 for further processing. The USB port 308 may further support peripheral devices including input devices, authentication devices, or additional controllers.

The display unit 310 shows scanned address and operational metrics including but not limited to processing unit 108 running state indicator, number of scans done in a day, percentage of successful scans and average sorting time. The information in the display unit 310 helps the operator in speeding up the sorting process. The display unit 310 may be a Liquid Crystal Display (LCD) display. In some embodiments, the display unit 310 includes touchscreen capability for administrative or configuration functions.

The LED indicators 312 provide visual feedback on the operational status of the processing unit 108 by illuminating different colors for each specific state. The buzzer 316 emits beeps for a short duration when a garbage text or invalid item identifier is identified. The User Interface Unit 320 enables the operator to manually enter the street number or address when the processor fails to accurately extract item identifier from the image or when the identification subsystem 110 is unable to capture an image of the physical item. In some embodiments, the user interface unit 320 includes a numeric keypad or a full keyboard configured for numeric entry and command inputs.

The LED driver unit 314 regulates power and manages the operation of the LED strips that are connected to the sockets for LED strips 318. The LED driver 314 unit ensures a stable voltage and current supply, enabling proper illumination. The processor 302 controls the LED driver unit 314 to turn the LED strip on or off and adjust brightness. In some embodiments, the processor 302 is configured to generate LED protocol timing signals, receive serial commands and transmit to the LED driver unit 314 via USB or Universal asynchronous receiver/transmitter (UART) communication, and independently control multiple LED strip sets via respective GPIO outputs. The processor 302 translates received commands into LED serial data signals for updating LED illumination states with low latency. The sockets for LED strips 318 serve as a connection point for attaching the LED strips to the processing unit.

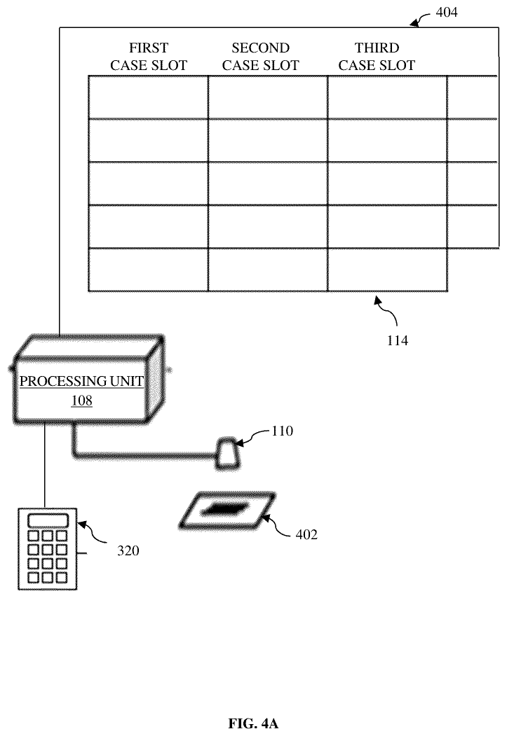

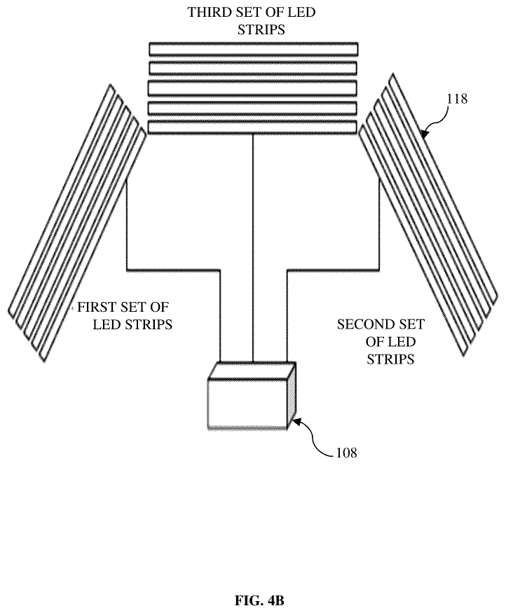

FIG. 4A illustrates an exemplary view of a structured storage environment 114 which in one embodiment represented as a postal mail casing station, according to some embodiments herein. The structured storage environment 114 includes one or more case slots with each case slot having one or more shelves (i.e. physical storage locations). FIG. 4A shows structured storage environment 114 with three case slots each having five shelves. The LED strips 404 (i.e. visual indicators) are added to the structured storage environment 114 and electrical wiring are done using cable of 4 core copper wire with overall diameter less then 6 mm. The LED strips 404 are connected to the processing unit 108 through the sockets for LED strips 318. FIG. 4A also illustrates a process in which a mail (i.e. physical item) 402 that needs to be sorted is kept under the identification subsystem 110 to capture an image of that mail 402. FIG. 4A also shows the user interface unit 320 which helps the operator to interact with the processing unit 108.

FIG. 4B illustrates an exemplary view of a visual indicator 118 connectivity, depicting multiple sets of LED strips connected to a processing unit 108 according to some embodiments herein. The visual indicator 118 includes addressable RGB LED strips. The three sets of LED strips include a first set of LED strips, a second set of LED strips and a third set of LED strips. Within each set, strips are daisy-chained. Each case slot of a structured storage environment 114 is added with a set of LED strips. Each LED strips are of length up to one meter which is connected by electrical wiring harness and finally connection gets terminated at sockets of LED strips 318 provided on the processing unit 108. Each LED strip may have 60 LEDs per meter length and this is increased or decreased as per needs. Each case slot has five shelves and needs total of 900 LEDs considering one-meter length of case slot. The three sets of LED strips are connected to the processing unit using three sets of cables. The LED strips are organized into sets such that each set corresponds to a respective case slot or storage section. Within each set, a first LED strip includes a data-input terminal connected to a processor and a data-output terminal connected to a subsequent LED strip. The one or more intermediate LED strips each include a data-input terminal connected to a preceding strip and a data-output terminal connected to a succeeding strip. The last LED strip includes a data-input terminal connected to a preceding strip while its data-output terminal remains unused. A single data line from the processing unit 108 is configured to control an entire set, and multiple sets are controllable via respective data lines.

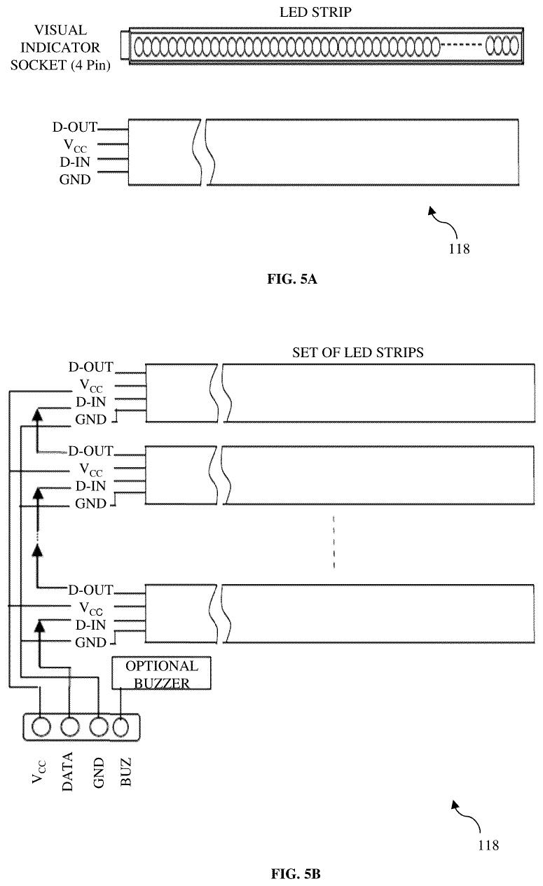

FIGS. 5A and 5B illustrate detailed view of a visual indicator 118, showing individual addressable elements and daisy-chain topology according to some embodiments herein. Each LED strip has 60 LEDs distributed across the length of one meter as seen in FIG. 5A. The visual indicator 118 includes a set of addressable RGB LED strips as seen in FIG. 5B. The length is customized as per the rack size at structured storage environment 114. Separate harness needed to connect each strip together as only one cable come from the processing unit 108 to a rack. The V_{CC} pin supplies a +5V Direct Current (DC) power source to the LED strip. The ground (GND) pin serves as the return path for the DC power, completing the electrical circuit. The D-In pin is responsible for receiving control signals from the processing unit 108, allowing the LEDs to be controlled accordingly. The D-Out pin is used when multiple LED strips are connected in sequence in order to transfer data from one LED strip to the next LED strip.

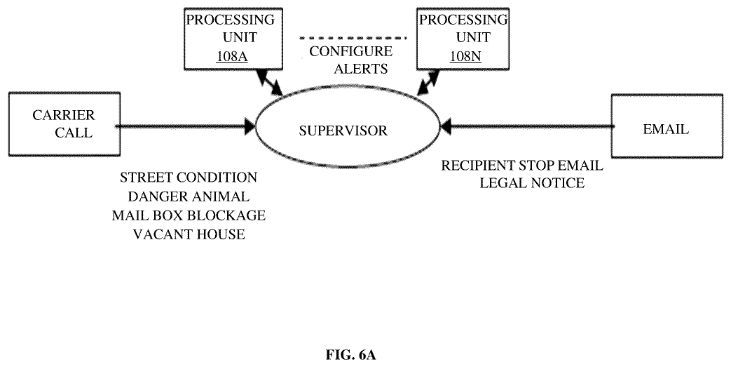

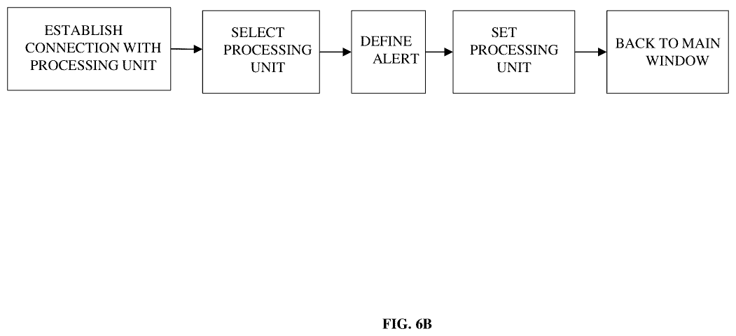

FIG. 6A illustrates workflow for configuring conditional attributes or alerts in one or more processing units 108A-N by a supervisor, including setting alerts for special handling requirements according to some embodiments herein. The Supervisor using the software application is able to set or clear the conditional attributes at one or more processing units 108A-N. The supervisor is allowed to manage Change of Address across the one or more processing units 108A-N in a post office and the carrier get alert for Change of Address (COA) or forwarding Address on user interface unit. The Supervisor also manages alerts for conditions including but not limited to vacant or unoccupied address, blocked mailbox, hazardous condition along the route, deceased resident, and centralized mail delivery by setting up defined alerts to carrier.

FIG. 6B illustrates workflow for establishing network communication and defining alerts according to some embodiments herein. In order to configure one or more processing units 108A-N, fixed IP addresses are setup at each processing unit 108 and same to be configured in the software application for communication between them. Each processing unit 108 will have unique device identity, manufacturing serial number and software application to recognize each processing unit 108 and exchange data. After establishing connection with each processing unit 108, the supervisor is able to set alerts. The supervisor defines the alert as per needs. For example, an alert is defined such that the buzzer beeps when the item identifier is invalid.

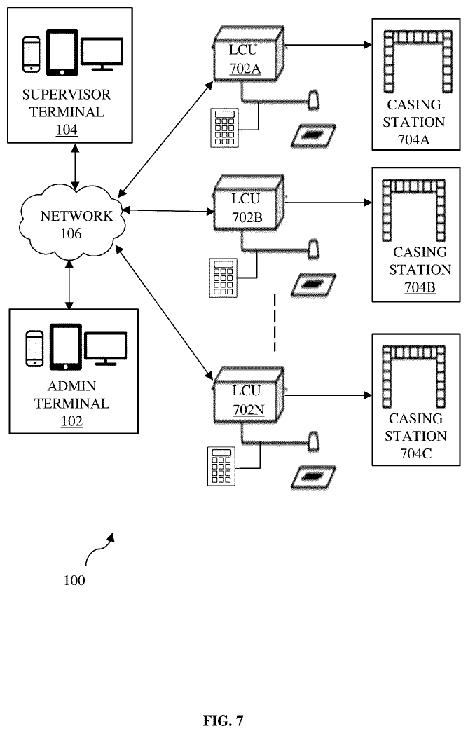

FIG. 7 illustrates an exemplary implementation of a system 100 deployed in a postal mail sorting environment. The system 100 deployed in the postal mail sorting environment includes an admin terminal 102, a supervisor terminal 104, a network 106, one or more Local Casing Units (LCUs) (i.e. processing units) 702A-N and one or more casing stations (i.e. structured storage environment) 704A-N. The admin terminal 102 is used by an admin to disable or enable existing supervisor names, add one or more LCUs 702A-N, commission new casing desk for route and configure specific Light Emitting Diodes (LED) colors (i.e. visual indicators) as per the needs. The supervisor terminal 104 is used by a supervisor to access and manage each LCU 702 for adding, updating and deleting conditional flags or alerts for carrier. The Supervisor also able to read LCU data for analysis and reporting. The Supervisor using the software application is able to set or clear the flags at one or more LCUs 702A-N for any danger at recipient house, flag to hold or restart the delivery of post in response to requests from recipient's, and stop mail as per received legal orders. The supervisor is allowed to manage Change of Address across one or more LCUs 702A-N in a post office and the carrier gets alert for Change of Address (COA) or forwarding address on the user interface unit.

The supervisor manages alerts for conditions including but not limited to vacant or unoccupied address, blocked mailbox, hazardous condition along the route, deceased resident, and centralized mail delivery by setting up defined alerts to carrier. The supervisor and the admin are able to access and manage each LCU 702 using a software application that is accessed using the supervisor terminal 104 and the admin terminal 102. The admin and the supervisor may successfully login on to the software application using user credentials. The software application may be a GUI-based window application that helps in initial setup to configure the one or more LCUs 702A-N as per carrier route and set notifications and alerts for the carrier.

The Admin terminal 102 and the supervisor terminal 104 may be a handheld device, a mobile phone, a kindle, a Personal Digital Assistant (PDA), a tablet, a laptop, a desktop computer, a wearable device, an electronic notebook, a smartphone, a stationary device, a partially-stationary device or a non-traditional user device like IoT (Internet of Things) nodes. The admin terminal 102, supervisor terminal 104 and the one or more LCUs 702A-N connected to each other through the network 106. In some embodiments, the network 106 is a wired network, a wireless network, or an Ethernet network. In some embodiments, the network 106 is a combination of a wired, wireless, and Ethernet network. In some embodiments, the network 106 is Internet.

The one or more LCUs 702A-N are configured through initial pairing that is done during commission of the one or more LCUs 702A-N for the one or more casing stations 704A-N. Each LCU 702 has fixed IP addresses and same need to be configured in the software application for communication between them. Each LCU 702 has a unique device identity, a manufacturing serial number and the software application to recognize it and exchange data. The admin sets any preferred LED colors for postal worker. The software application helps to quickly set up the system 100 for a post office using Standard Operating Procedure (SOP).

Each LCU 702 is connected to an image capturing device (i.e. identification subsystem). The image capturing device may be a camera. The postal mail or mail is placed under the image capturing device that is connected to the first LCU 702A to capture an image of the mail. The image is then sent to the first LCU 702A for processing. The image is processed to check for text. If there is no text, then the image of the mail is captured again until the image contains text. After checking for text, the image is processed to check for valid address. If the address is not valid, then the image of the mail is captured again until the image contains a valid address. After checking for valid address, the image is processed to extract the address using an Optical Character Recognition (OCR) technique. Based on the extracted address, the alerts are enabled. The address may include a recipient name, street name or number, city and zip code. The alerts are indicated using LED strips that are embedded in the first casing station 704A and a buzzer. The address corresponds to the recipient's address. The LED strip may be a Red, Blue and Green (RGB) LED strip. The first LCU 702A alerts the carrier using a buzzer that beeps for duration. The buzzer emits beeps for a short duration when a garbage text or invalid text is found during the extraction of address. The first casing station 704A includes one or more case slots that are added with LED strips. Each case slot includes one or more shelves. From the first LCU 702A, set of cables runs to each case slot of the first casing station 704A to control the LEDs in the LED strips. Multiple color options are available as programmable RGB LEDs are used here. To clearly distinguish different defined alerts basic color are preferable and the supervisor is allowed to set that. The LEDs illuminates white color during casing of mail to find route.

The system 100 deployed in the postal mail sorting environment is capable to illuminate a single LED which will be seen to carrier as a single dot, or if configured for more than one, the first LCU 702A illuminates a set of adjoining LEDs and this may be seen as glowing LED line and number of LED should glow in the line is also be configured for specific conditions of the address. Based on the address, the LEDs in the LED strips are controlled and illuminated. The shelf under the illuminated LED or a set of adjoining LEDs corresponds to a casing location of the mail that needs to be sorted. The casing location of the mail corresponds to a location in the first casing station 704A where the mail needs to be placed during the process of casing. The color that is being illuminated by the LED or the set of adjoining LEDs of the LED strip indicates congestion levels and potential road hazards along the route based on a color. For example, the color red may indicate that there are potential hazards along the route and color yellow may indicate moderate traffic along the route. The mail is then placed in the casing location that is being indicated. Similarly, the one or more LCUs 702A-N in the system 100 follows the same sequence of operations to determine the casing location of the mail.

The system 100 efficiently processes and sorts the mail by digitizing the process of casing. The supervisor may assign anyone not trained on the route to case the mail and they would be able to accomplish it in quicker time than the current process allows for someone who is trained on the route. The system 100 efficiently streamlines the postal operations by significantly reducing the amount of time it takes to case the mail and free up manpower to do more package delivery increasing a profitable revenue stream. The system 100 also utilizes data analytics improve the overall casing efficiency in a post office. In addition, route specific details are added such as warnings about delivery locations and hold mail requests further helping to bring the process of casing the mail in an efficient manner.

The system 100 may also be employed across multiple application domains, including (i) postal and logistics environments for mail and package sortation at post offices, courier hubs, and processing centers, (ii) healthcare settings such as hospitals, nursing homes, assisted living facilities, and pharmacies for medication distribution, prescription fulfillment, and specimen handling, (iii) warehouse and distribution facilities for order picking and inventory management, (iv) manufacturing environments for parts picking, bill-of-materials verification, and inspection routing, (v) secure or regulated locations including evidence rooms, legal document repositories, controlled-substance storage, and classified-material facilities, and (vi) laboratory or research environments for specimen routing and sample tracking.

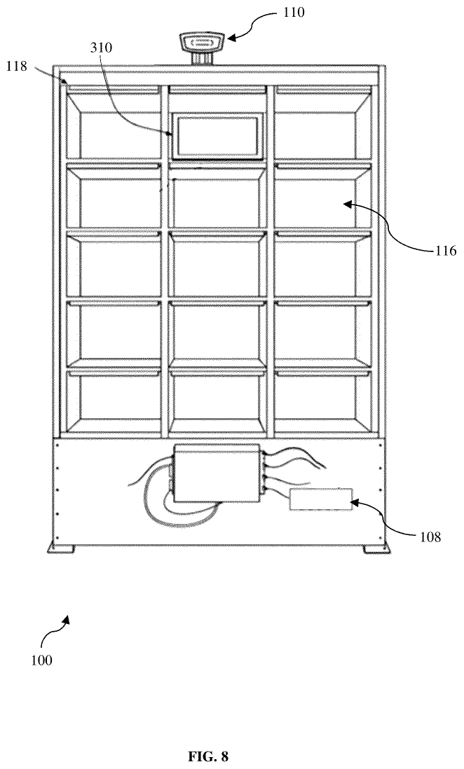

FIG. 8 illustrates an exemplary view of a system 100 implemented in a parcel locker configuration. As seen in FIG. 8, the system 100 includes one or more vertically arranged locker compartments (i.e. physical storage locations) 116 to store physical items. Each compartment opening includes visual indicator 118 along the openings. The system includes an identification subsystem (i.e. barcode scanner) 110 is provided for scanning item identifiers associated with the physical items. The identification subsystem 110 is shown mounted above the locker assembly, however, in alternative implementations the identification subsystem 110 may be provided as a handheld scanner, a ring scanner, or any other portable scanning device. The system 100 includes a display unit 310 configured to present instructions or information to the operator. The display unit 310 is mounted externally on a side portion of the locker assembly facing the operator. The system 100 includes a processing unit 108 that is operatively connected to the identification subsystem 110, the one or more visual indicators 118A-N, and the display unit 310 to control system 100 operations. The system 100 determines target physical storage location corresponding to the physical item and activates one or more visual indicators 118A-N associated with the target physical storage location (i.e. the target locker compartment), thereby reducing the cognitive load associated with mapping the physical item to target physical locations while maintaining operator control over physical item placement. The operator then retrieves or places the physical item in the illuminated target locker compartment.

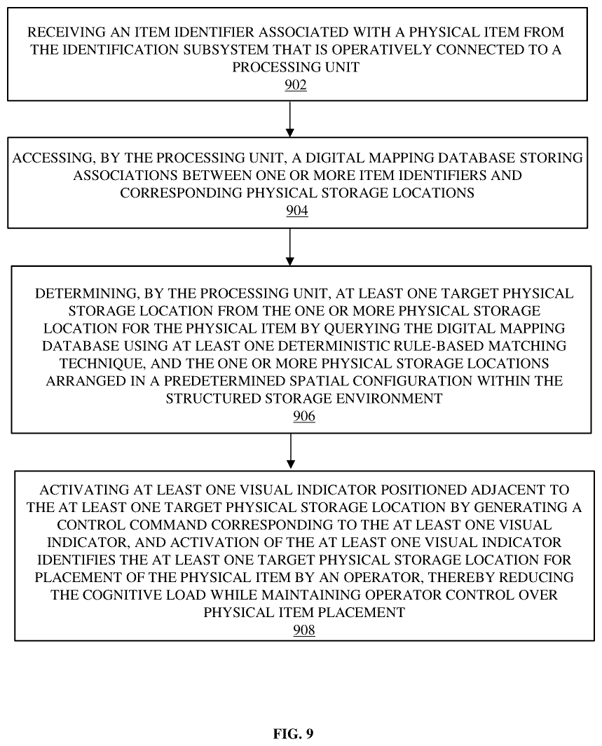

FIG. 9 is a flow diagram that illustrates a method for reducing cognitive load associated with mapping one or more physical items to one or more physical storage locations 116A-N for placement of the one or more physical items in a structured storage environment 114 according to some embodiments herein. At step 902, the method includes receiving an item identifier associated with a physical item from the identification subsystem 110 that is operatively connected to a processing unit 108. At step 904, the method includes accessing, by the processing unit 108, a digital mapping database storing associations between one or more item identifiers and corresponding physical storage locations. At step 906, the method includes determining, by the processing unit 108, at least one target physical storage location from the one or more physical storage locations 116A-N for the physical item by querying the digital mapping database using at least one deterministic rule-based matching technique. The one or more physical storage locations 116A-N arranged in a predetermined spatial configuration within the structured storage environment. At step 908, the method includes activating at least one visual indicator positioned adjacent to the at least one target physical storage location by generating a control command corresponding to the at least one visual indicator, and activation of the at least one visual indicator identifies the at least one target physical storage location for placement of the physical item by an operator, thereby reducing the cognitive load while maintaining operator control over physical item placement.

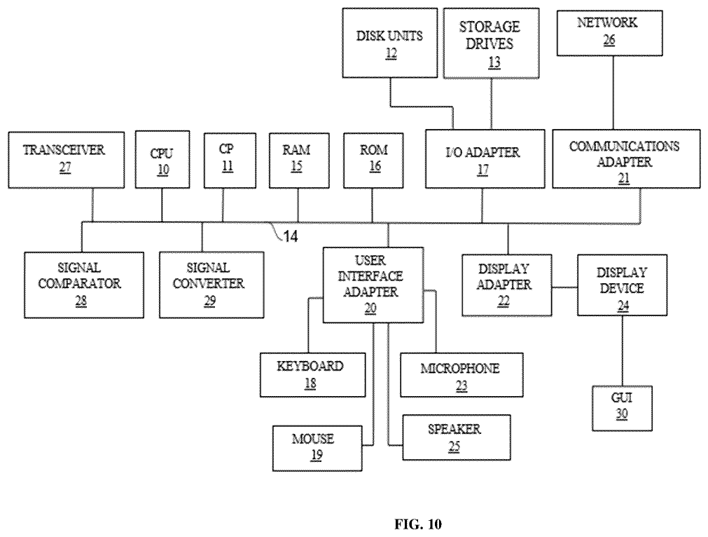

A representative hardware environment for practicing the embodiments herein is depicted in FIG. 10, with reference to FIGS. 1 through 9. This schematic drawing illustrates a hardware configuration of a server/computer system/computing device in accordance with the embodiments herein. The system includes at least one processing device CPU 10 that may be interconnected via system bus 14 to various devices such as a random-access memory (RAM) 15, read-only memory (ROM) 16, and an input/output (I/O) adapter 17. The I/O adapter 17 can connect to peripheral devices, such as disk units 12 and program storage drives 13 that are readable by the system. The system can read the inventive instructions on the program storage devices 13 and follow these instructions to execute the methodology of the embodiments herein. The system further includes a user interface adapter 20 that connects a keyboard 18, mouse 19, speaker 25, microphone 23, and/or other user interface devices such as a touch screen device (not shown) to the bus 14 to gather user input. Additionally, a communication adapter 21 connects the bus 14 to a display adapter 22, and the display adapter 22 connects the bus 14 to a display device 24, which provides a graphical user interface (GUI) 30 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope.

What is claimed is:

1. A computer-implemented system for reducing cognitive load associated with mapping a plurality of physical items to a plurality of physical storage locations for placement of the plurality of physical items in a structured storage environment, wherein the system comprises:
the plurality of physical storage locations arranged in a predetermined spatial configuration within the structured storage environment;
a plurality of visual indicators, wherein each visual indicator is positioned adjacent to at least one of the plurality of physical storage locations;
an identification subsystem configured to receive an item identifier associated with each of the plurality of physical items via at least one input unit; and
a processing unit operatively connected to the identification subsystem and to the plurality of visual indicators, wherein the processing unit is configured to:
receive the item identifier associated with a physical item from the identification subsystem;
access a digital mapping database storing associations between a plurality of item identifiers and corresponding physical storage locations;
determine, by querying the digital mapping database using at least one deterministic rule-based matching technique, at least one target physical storage location from the plurality of physical storage locations for the physical item; and
activate at least one visual indicator positioned adjacent to the at least one target physical storage location by generating a control command corresponding to the at least one visual indicator, wherein activation of the at least one visual indicator identifies the at least one target physical storage location for placement of the physical item by an operator, thereby reducing the cognitive load while maintaining operator control over physical item placement.

2. The computer-implemented system of claim 1, wherein the system comprises (i) a plurality of processing units, each associated with a respective structured storage environment, and (ii) a configuration management subsystem configured to distribute the digital mapping database to the plurality of processing units.

3. The computer-implemented system of claim 2, wherein the configuration management subsystem comprises a central server configured to maintain master configuration data and synchronize the data to the plurality of processing units through a network communication, wherein each processing unit is configured to operate autonomously using locally stored configuration data when network connectivity is unavailable.

4. The computer-implemented system of claim 1, wherein the system comprises:
a fault management subsystem configured to detect failure of the at least one input unit or visual indicator, and to continue operation using at least one remaining functional input unit or visual indicator; and
a session management subsystem configured to associate physical item placement operations with authenticated operators, wherein the session management subsystem enforces session termination based on operator inactivity.

5. The computer-implemented system of claim 1, wherein the system normalizes the item identifier to a canonical representation by (i) converting the item identifier to a lowercase format, (ii) removing punctuation characters except required characters, (iii) standardizing whitespace within the item identifier, (iv) correcting predefined optical character recognition (OCR) errors, and (v) normalizing suffixes associated with the item identifier.

6. The computer-implemented system of claim 1, wherein the physical item comprises a postal mail piece bearing delivery address information.

7. The computer-implemented system of claim 6, wherein the structured storage environment comprises a mail casing station having shelves arranged according to delivery sequence.

8. The computer-implemented system of claim 6, wherein the item identifier comprises delivery address text extracted through an optical character recognition.

9. The computer-implemented system of claim 1, wherein the physical item comprises medication containers associated with individual patients.

10. The computer-implemented system of claim 9, wherein the item identifier comprises at least one of patient identifiers, medication identifiers, or encoded prescription information.

11. The computer-implemented system of claim 1, wherein the physical item comprises inventory items identified by stock-keeping units (SKUs).

12. The computer-implemented system of claim 11, wherein the structured storage environment comprise bins arranged according to fulfillment or assembly workflows.

13. The computer-implemented system of claim 1, wherein authentication of the operator is performed via at least one of (i) numeric login code entry, (ii) machine-readable authentication token scanning, or (iii) manual operator selection, wherein the numeric login code comprises a site identifier, route identifier, and checksum component.

14. A computer-implemented system to resolve item identifier to at least one target storage location from a plurality of physical storage locations arranged in a predetermined spatial configuration within a structured storage environment, wherein the system comprises:
an identification subsystem configured to receive the item identifier associated with each of the plurality of physical items via at least one input unit, wherein the identification subsystem is configured to receive the item identifier through the at least one input unit comprising one or more of: (i) a numeric input through an alphanumeric input device, (ii) optical recognition through image capture and pattern recognition, (iii) machine-readable code scanning, or (iv) manual selection through user interface associated with the identification subsystem; and
a processing unit operatively connected to the identification subsystem, wherein the processing unit is configured to resolve item identifier received from the at least one input device to the at least one target storage location using a common digital mapping.

15. The computer-implemented system of claim 14, wherein the optical recognition is performed using a graphics processing unit (GPU) that is configured to execute machine learning inference operations for the pattern recognition.

16. A computer-implemented system to modify at least one visual characteristic of at least one activated visual indicator, wherein the system comprises:
a processing unit operatively connected to a plurality of visual indicators, wherein each visual indicator is positioned adjacent to at least one of a plurality of physical storage locations, wherein the processing unit is configured to:
activate at least one visual indicator positioned adjacent to at least one physical storage location; and
execute a metadata storage mechanism associating conditional attributes with at least one item identifier or at least one physical storage location, wherein an item identifier is associated with each of the plurality of physical items; and
visual indicator control subsystem configured to modify the at least one visual characteristic of the at least one activated visual indicator based on the conditional attributes, wherein the conditional attributes comprise at least one of access restrictions, special handling requirements, hazard warnings, or time-sensitive conditions.

17. The computer-implemented system of claim 16, wherein the system comprising a display unit configured to present conditional attribute details when the at least one visual characteristic of the at least one activated visual indicator is modified.

18. The computer-implemented system of claim 16, wherein the plurality of visual indicators comprises individually addressable RGB light-emitting elements, and the at least one visual characteristic comprises at least one of color, illumination pattern, or illumination duration.

19. The computer-implemented system of claim 16, wherein the conditional attributes comprise medication contraindications or allergy indicators.

20. A method for reducing cognitive load associated with mapping a plurality of physical items to a plurality of physical storage locations for placement of the plurality of physical items in a structured storage environment, comprising:
receiving an item identifier associated with a physical item from the identification subsystem that is operatively connected to a processing unit;
accessing, by the processing unit, a digital mapping database storing associations between a plurality of item identifiers and corresponding physical storage locations;
determining, by the processing unit, at least one target physical storage location from the plurality of physical storage locations for the physical item by querying the digital mapping database using at least one deterministic rule-based matching technique, wherein the plurality of physical storage locations arranged in a predetermined spatial configuration within the structured storage environment; and
activating at least one visual indicator positioned adjacent to the at least one target physical storage location by generating a control command corresponding to the at least one visual indicator, wherein activation of the at least one visual indicator identifies the at least one target physical storage location for placement of the physical item by an operator, thereby reducing the cognitive load while maintaining operator control over physical item placement.
